(19) United States
(12) Patent Application Publication
(10) Pub. No.: US 2025/0135718 A1
(43) Pub. Date: May 1, 2025

(54) Method for Additively Manufacturing Components

(71) Applicant: Bayerische Motoren Werke Aktiengesellschaft, Muenchen (DE)

(72) Inventors: Martin HOEGL, Ergolding (DE); Eva HONICKEL, Eching (DE); Franz MAIDL, Eichendorf (DE)

(21) Appl. No.: 18/838,025

(22) PCT Filed: Apr. 19, 2023
(86) PCT No.: PCT/EP2023/060094

§ 371 Date: Aug. 13, 2024

(30) Foreign Application Priority Data
May 11, 2022 (DE) 10 2022 111 741.3

(51) Int. Cl. B29C 64/182; B29C 64/118; B29C 64/209; B29C 64/227; B33Y 10/00; B33Y 30/00

(52) U.S. Cl. CPC B29C 64/182; B29C 64/118; B29C 64/209; B29C 64/227; B33Y 10/00; B33Y 30/00

(57) ABSTRACT

Please substitute the new Abstract submitted herewith for the original Abstract: A method and device for additively manufacturing components. In the method and device, a printing device is provided for additively manufacturing components, wherein the printing device comprises an extruder apparatus, a manifold apparatus connected to the extruder apparatus, and a plurality of spaced-apart nozzles. Furthermore, a plurality of components are manufactured by the printing device, wherein extrusion material is conveyed from the extruder apparatus via the manifold apparatus to the nozzles, and wherein the components are manufactured simultaneously.

### BACKGROUND AND SUMMARY

A method for additively manufacturing components is specified.

Numerous generative manufacturing methods—also known as additive manufacturing or 3D printing methods—are known in the prior art. These are computer-controlled methods in which components are produced from liquid or solid materials according to predefined dimensions and shapes by way of chemical and/or physical processes, in particular by way of melting and/or hardening processes. Generative manufacturing methods are suitable, inter alia, for economical production of prototypes, one-offs or components with complex geometry.

In melt-based printing methods known currently in the prior art, for example fused deposition modeling (FDM), fused filament fabrication (FFF), or fused granular fabrication (FGF), an individual print head (nozzle) is used to print components. Furthermore, use is also made of print heads that run in parallel, for example in gantry systems (for example desktop printers).

Publication DE 10 2019 124 311 A1 discloses a nozzle arrangement for an extruder head which is used in an additive manufacturing system. The extruder head comprises an arrangement of multiple nozzles in a front plate. The nozzles are integrated in a common head, with rotation about the axis and activation of the respective nozzles allowing them to be used for the component-forming process. This enables more efficient printing or the printing of different materials.

An object to be achieved by at least some embodiments is that of specifying a method for additively manufacturing components which can considerably reduce the build time per component and thus the production costs of components.

According to at least one embodiment, in the method described here, a printing apparatus for additively manufacturing components is provided. The printing apparatus comprises an extruder device, a distributor device connected to the extruder device, and a multiplicity of nozzles spaced apart from one another. The extruder device is preferably a central extruder for melting the material to be printed. The extruder device, which is preferably static in the production environment, thus serves for the central supply of material or melt. The distributor device is preferably a distributor system for conducting melt or for conducting the extrusion material. By way of example, the distributor system may be a hot runner system manufactured from injection molds. Via the distributor device or the distributor system, the melt or the extrusion material can be conveyed to the nozzles which are connected directly to the distributor device. The nozzles may, for example, be arranged at a uniform spacing from one another, that is to say all the nozzles that are directly adjacent to one another may each have the same spacing. Furthermore, the spacing between two adjacent nozzles is preferably in each case greater than a lateral extent of the components manufactured or to be manufactured or greater than the individual component dimensions of the components in the x direction and/or y direction (the z direction, which runs perpendicularly with respect to the x direction and y direction, here denotes the direction in which the components are built up during the printing or in which a component platform, on which the components are printed in the method, can be moved or lowered). The nozzles may, for example, be arranged at a uniform spacing from one another in one dimension (e.g., in the x direction, or in the y direction), or in two dimensions (e.g., in the x direction and the y direction).

Furthermore, in the method, a multiplicity of components are manufactured by way of the printing apparatus, wherein extrusion material is conducted from the extruder device via the distributor device to the nozzles, and wherein the components are manufactured at the same time or simultaneously. Preferably, in the method, a separate component is manufactured by each of the nozzles. The components manufactured or to be manufactured by the method may in particular each be identical. Preferably, the components are manufactured in the method in such a way that component portions which are identical with regard to all the components are built up or printed simultaneously.

Preferably, the manufacture of the components or an additive manufacturing method is a melt-based printing method. By way of example, the manufacturing method may be what is known as a fused deposition modeling (FDM) method, a fused filament fabrication (FFF) method or a fused granular fabrication (FGF) method.

According to a further embodiment, the printing apparatus comprises a movable build platform or component platform on which extrusion material emitted by the nozzles is printed in the method described here or during the manufacturing of the components. Furthermore, the printing apparatus may comprise an actuator for moving the component platform, in particular for moving the component platform in the z direction. The actuator may, for example, be a manipulator or robot.

The nozzles of the printing apparatus may preferably be arranged with respect to the component platform in such a way that they are each at the same spacing to the component platform. This makes it possible in a particularly simple manner for a multiplicity of components to be printed or manufactured simultaneously or at the same time by the method described here, wherein the components manufactured by the method are preferably each identical.

Typically, in the production of 3D components, the build time is a very time-intensive and thus important factor for the production costs of printed components. The method described here advantageously makes it possible to considerably reduce the build times and thus to considerably reduce the production and/or capital costs.

Further advantages of the method described here for additively manufacturing components will emerge from the embodiment described below in connection with FIG. 1.

### BRIEF DESCRIPTION OF THE DRAWING

The elements illustrated in the figure and their proportions to one another should fundamentally not be regarded as true to scale; rather, individual elements may be illustrated with exaggerated thickness or with large dimensions for better presentability and/or for better understanding.

FIG. 1 shows a schematic illustration of a method described here for additively manufacturing components.

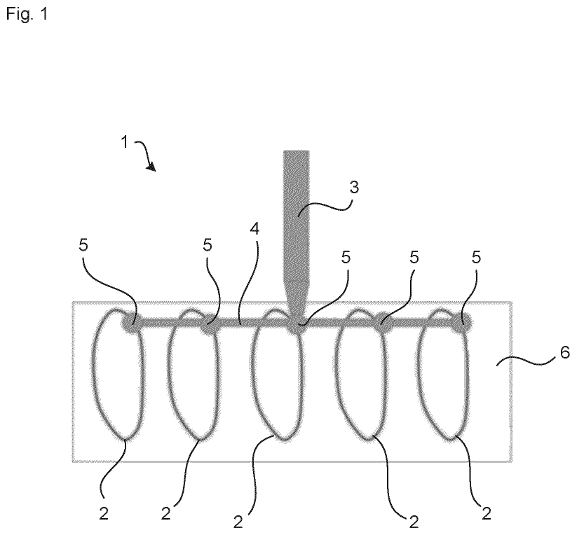

### DETAILED DESCRIPTION OF THE DRAWING

In the method, a printing apparatus 1 for additively manufacturing components 2 is provided. The printing apparatus 1 comprises a central extruder device 3 for melting the material to be printed and a distributor device 4 connected to the extruder device 3. The distributor device 4 may, for example, be in the form of at least one melt distribution duct and may, for example, be a hot runner system produced from injection molds. Furthermore, the printing apparatus 1 comprises a multiplicity of nozzles 5 which are spaced apart from one another and are connected to one another via the distributor device 4.

In addition, the printing apparatus 1 comprises a component platform 6 which is movable by an actuator or robot (not illustrated). In the method, a multiplicity of components 2 are manufactured simultaneously by way of the printing apparatus 1, wherein extrusion material is conducted from the extruder device 3 via the distributor device 4 to the individual nozzles 5 and the extrusion material is printed onto the planar component platform 6 by way of the nozzles 5. With the aid of the actuator or robot, the planar build platform 6, on which the printed parts or components 2 are built up, can be moved under the outlet of the nozzles 5. It is thus possible for the components 2 to be printed or manufactured at the same time by way of the multiplicity of nozzles 5, which are fed with extrusion material via the common extruder device 3 and the distributor device 4. In particular, in the method, a separate component 2 may be manufactured by each of the nozzles 5. The individual components manufactured by the method are preferably each of identical form after the printing operation is complete. The printing method may, in particular, be a melt-based printing method.

Through the use of the method described here, it is in particular possible for the build time to be reduced considerably in melt-based printing methods, and specifically when using extruder technology (e.g. direct printing from granular material, pellet printing) in the production of two or more components 2. By way of example, when using two nozzles, the build time can be halved, or the investment in an additional installation (depending on the batch size) prevented.

As an alternative or in addition, the exemplary embodiment shown in the figure may have further features according to the embodiments of the general description.

### LIST OF REFERENCE DESIGNATIONS

1 Printing apparatus
2 Component
3 Extruder device
4 Distributor device
5 Nozzle
6 Build platform

1.-8. (canceled)

9. A method for additively manufacturing components, comprising:
providing a printing apparatus for additively manufacturing components, wherein the printing apparatus comprises an extruder device, a distributor device connected to the extruder device, and a multiplicity of nozzles spaced apart from one another, and
manufacturing a multiplicity of components by the printing apparatus, wherein extrusion material is conducted from the extruder device via the distributor device to the nozzles, and
wherein the components are manufactured simultaneously.

10. The method according to claim 9, wherein a separate component is manufactured by each of the nozzles.

11. The method according to claim 9, wherein the components are manufactured simultaneously by a melt-based printing method.

12. The method according to claim 9, wherein the spacing between two adjacent nozzles is greater than a lateral extent of the components to be manufactured.

13. The method according to claim 9, wherein the printing apparatus comprises a movable component platform on which extrusion material emitted by the nozzles is printed during the manufacturing of the components.

14. The method according to claim 13, wherein the printing apparatus comprises an actuator for moving the component platform.

15. The method according to claim 13, wherein the nozzles are arranged with respect to the component platform in such a way that they are each at the same spacing to the component platform.

16. The method according to claim 9, wherein the components manufactured or to be manufactured by the method are each identical.

17. A printing device for additively manufacturing components simultaneously, comprising:
an extruder for melting material into a melt to be printed,
at least one melt duct connected to the extruder for distributing the melt, and,
a multiplicity of nozzles spaced apart from one another, wherein each nozzle of the multiplicity of nozzles are connected to one another via the at least one melt distribution duct.

18. The printing device of claim 17, wherein the extruder is static in a production environment.

19. The printing device of claim 17, wherein the extruder is centrally located relative to the multiplicity of nozzles.

20. The printing device of claim 17, wherein each nozzle of the multiplicity of nozzles are uniformly spaced apart from one another.

21. The printing device of claim 20, wherein each nozzle of the multiplicity of nozzles are spaced apart in one dimension.

22. The printing device of claim 20, wherein each nozzle of the multiplicity of nozzles are spaced apart in two dimensions.

23. The printing device of claim 17, wherein the melt is simultaneously distributed to each nozzle of the multiplicity of nozzles through the at least one melt duct.

24. The printing device of claim 17, further comprising a component platform moveable relative to the multiplicity of nozzles.

25. The printing device of claim 24, wherein the component platform is moveable relative to the multiplicity of nozzles in a z direction.

26. The printing device of claim 24, wherein the component platform is moveable via an actuator.

27. The printing device of claim 24, wherein each of the multiplicity of nozzles are at the same spacing relative to the component platform.
